(19) United States
(12) Patent Application Publication
(10) Pub. No.: US 2023/0418737 A1
(43) Pub. Date: Dec. 28, 2023

(54) SYSTEM AND METHOD FOR MULTIMODAL COMPUTER ADDRESS SPACE PROVISIONING

(71) Applicant: UNIFABRIX LTD., Haifa (IL)

(72) Inventors: Ronen Aharon HYATT, Haifa (IL); Danny VOLKIND, Nesher (IL)

(73) Assignee: UNIFABRIX LTD., Haifa (IL)

(21) Appl. No.: 18/243,128

(22) Filed: Sep. 7, 2023

Related U.S. Application Data
(63) Continuation of application No. 17/540,466, filed on Dec. 2, 2021, now abandoned.
(60) Provisional application No. 63/120,252, filed on Dec. 2, 2020.

(51) Int. Cl. G06F 12/02; G06F 12/1045; G06N 20/00; G06F 9/46; G06F 13/16; G06F 18/214; G06F 12/1036

(52) U.S. Cl. CPC G06F 12/0238; G06F 12/1045; G06N 20/00; G06F 9/467; G06F 13/1668; G06F 18/214; G06F 12/1036

(57) ABSTRACT

A computer based system and method for managing memory resources in a computing system may include, using a computer processor, receiving, from a computing system, a memory transaction request originating from a process executing on the computing system. Translation of a memory address associated with the request, or provisioning of memory for a translated address, may be determined based on various memory-transactions-related metadata—such as the service level of the process; the service level of other processes; access patterns of memory resources; a prediction of future memory requests of a process, and the like.

### PRIOR APPLICATION DATA

The present application is a Continuation of U.S. patent application Ser. No. 17/540,466, filed on Dec. 2, 2021, which claims benefit from U.S. Provisional Patent Application No. 63/120,252 filed on Dec. 2, 2020, entitled SYSTEM AND METHOD OF MULTIMODAL ADDRESS SPACE PROVISIONING, which are incorporated by reference herein in their entirety.

### FIELD OF THE INVENTION

The present invention relates generally to memory address translation and management of memory resources in a computing system.

### BACKGROUND OF THE INVENTION

Modern computing systems typically use multiple hierarchies of address spaces, virtual or physical, as well as software-based or hardware-based address translations between the hierarchies—e.g., between host virtual address (HVA) and host physical address (HPA)—carried out in a physical or virtual memory management unit (MMU or vMMU) or an I/O memory management unit (IOMMU or vIOMMU) of a CPU or a GPU. When a program/code executing on a processor is trying to access a virtual address (e.g., HVA) this address needs first to be translated down the virtualization hierarchy into an actual physical resource that can be consumed by the processor hardware. An address or memory translation entity, e.g., the MMU, typically implemented in appropriate hardware mechanisms in the processor, may be responsible for carrying out such translation.

In such systems, the operating system (OS) may be responsible for configuring software-based or hardware-based translation structures; e.g., via configuring memory-resident page tables (PTs). When memory allocations are made, for instance, in the virtual address space, the OS would configure corresponding address translation entries into the translation structures—by, e.g., adding page table entries (PTEs) that map blocks or ranges of virtual addresses into the corresponding blocks or ranges of physical addresses. The translation mechanism may include, e.g., translation lookaside buffers (TLBs), page-table walkers (PTWs), translation caches, etc. In certain architectures, address translation may additionally involve different combinations of software, firmware, and/or hardware.

In cases where a requested address translation is not already cached in the address translation entity (e.g., in a TLB of the MMU), the address translation entity may consult the corresponding translation structures (e.g., page tables) that were previously configured by the OS—e.g., by reading page table entries (PTEs) previously written by the OS.

Other prior art memory management systems exist.

### SUMMARY OF THE INVENTION

A computer based system and method for managing memory resources in a computing system may include, using a computer processor, receiving, from a computing system, a memory transaction request originating from a process executing on the computing system. Translation of a memory address associated with the request, or provisioning of memory for a translated address, may be determined based on various memory-transactions-related metadata—such as the service level of the process; the service level of other processes; access patterns of memory resources; a prediction of future memory requests of a process, and the like. Translation or provisioning steps may be performed that are transparent to an operating system executing on the computing system, and several address spaces may be unified into a single address space.

### BRIEF DESCRIPTION OF THE DRAWINGS

Non-limiting examples of embodiments of the disclosure are described below with reference to figures attached hereto. Dimensions of features shown in the figures are chosen for convenience and clarity of presentation and are not necessarily shown to scale. The subject matter regarded as the invention is particularly pointed out and distinctly claimed in the concluding portion of the specification. The invention, however, both as to organization and method of operation, together with objects, features and advantages thereof, can be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 is a block diagram of an exemplary computing device which may be used with embodiments of the present invention.

FIG. 2 is a flow diagram of translation structure configuration associated with canonical-resource-address (CRA) and host-physical-address (HPA) provisioning according to some embodiments of the present invention.

FIG. 3 is a flowchart depicting a detailed memory allocation and provisioning procedure according to some embodiments of the present invention.

FIG. 4. illustrates an example software-defined management policy profiles table, which may be used in some embodiments of the present invention.

FIG. 5. is a flowchart depicting a simple process of managing memory resources in a computing system according to some embodiments of the present invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of the invention. However, it will be understood by those skilled in the art that the present invention can be practiced without these specific details. In other instances, well-known methods, procedures, and components, modules, units and/or circuits have not been described in detail so as not to obscure the invention.

When discussed herein, “a” computer processor performing functions may mean one computer processor performing the functions or multiple computer processors or modules performing the functions; for example, a process as described herein may be performed by one or more processors, possibly in different locations.

In the context of memory transactions and address translation, it is often desirable to abstract and virtualize the underlying physical structure of the system memory such that a more operationally flexible and customizable memory allocation, address translation and memory resource provisioning processes may take place. Such processes may be particularly beneficial, e.g., in cases where a group of servers share a single memory resource; in order to balance the memory load among different media; for the purpose of protecting against attacks from malicious code running on the processor; or in order to enable hybrid composition of system memory from multiple sources, from different physical locations—each having different characteristics and/or size. A memory transaction may be any memory access, e.g. a read or a write, by, for instance, a process or program.

Embodiments of the invention may allow performing memory allocations through multiple layers of address spaces using, for example, a unifying, multimodal address space (MAS), augmenting and/or replacing conventional memory allocations, address translations, and provisioning that are, in prior art systems, made directly from virtual memory to the physical memory address space. An MAS, abstracted on top of the underlying virtual memory address space and physical memory resources, may thus act as a unified, lower-layer native address space of the computer system as observed from the processor and software points of view. In some embodiments, the MAS may be composed of multiple address spaces. Thus embodiments may translate or provision to unify several address spaces into a single address space. An underlying multimodal management engine (MME) may be used to transparently (e.g., without interfering with hardware or software operations, such as those performed by the OS and memory management unit—such that the latter are not aware of the MME's operations) and dynamically (e.g., during process execution) determine either allocation, translation and provisioning of memory resources that may be formed from multiple memory tiers (e.g., persistent memory, remote memory, fast NVMe storage, and so forth), and may be found at different physical locations, to serve preceding allocations made in the MAS (by, e.g., the operating system) using appropriate translation structures (TSs) and meta structures. Such transparency may be transparent with respect to the preexisting system, e.g. transparent to the OS. Manipulations of data contained in such structures may allow the MME to further determine or manage and monitor additional properties of the memory resources such as historical translations and (re)placements and virtualizations, usage monitoring and health or memory resources (e.g., wear indications, error correction events, abnormal response patterns), and the like.

In some embodiments, the MAS is abstracted on top of the virtual and physical memory address spaces such that a given host physical address (HPA) or host virtual address (HVA) may be translated onto a multimodal native address (MNA) within the MAS. The MNA may then be translated by the MME onto a canonical resource address (CRA), representing a specific location within all memory resources available to the system (including, for instance, storage memory that is not readily available to a particular computer processor) and used for, e.g., provisioning of memory resources by the MME. The CRA may, in turn, be translated to a HPA by a memory management unit (MMU), leading to provisioning of physical memory as known in the art. While specific units such as an MME, CRA, MMU, etc. are discussed herein for the purpose of providing examples, other specific structures may be used with embodiments of the present invention.

Embodiments of the present invention, using an MME or other structure, may determine or complement existing (e.g. legacy or preexisting system) hardware translation, for example by providing further translation. The existing hardware and software instructions may be “fooled” and may not need to be modified. Embodiments may translate between an address space referenced by, for example, an OS, to another address space. Embodiments may collect telemetry metadata, such as a history of memory transactions or memory transaction requests, and access patterns per memory address, policies such as SLAs, and other data to decide how to translate between preexisting and new address spaces. Telemetry metadata and other data may help embodiments understand which memories are accessed more frequently and may include service level agreements (SLAs) of processes such as virtual machines (VMs) performing memory transactions. For example, a VM having a lower level service level agreement (SLA) might have its transactions assigned to a persistent memory which is cheaper than memory assigned to a VM having a higher SLA. Embodiments may input the service level of a process originating a memory transaction request (e.g. an application accessing memory) or the service level of other processes and in response, alter provisioning, or decide how to handle, store, or translate the memory transaction request. In some embodiments of the invention, telemetry metadata may be collected from internal busses within a hardware execution unit such as a processor core. In some other embodiments, where the execution entity is virtual and implemented purely in software, telemetry metadata may be collected from internal software transaction parameters associated with, e.g., a virtual execution unit such as a vCPU.

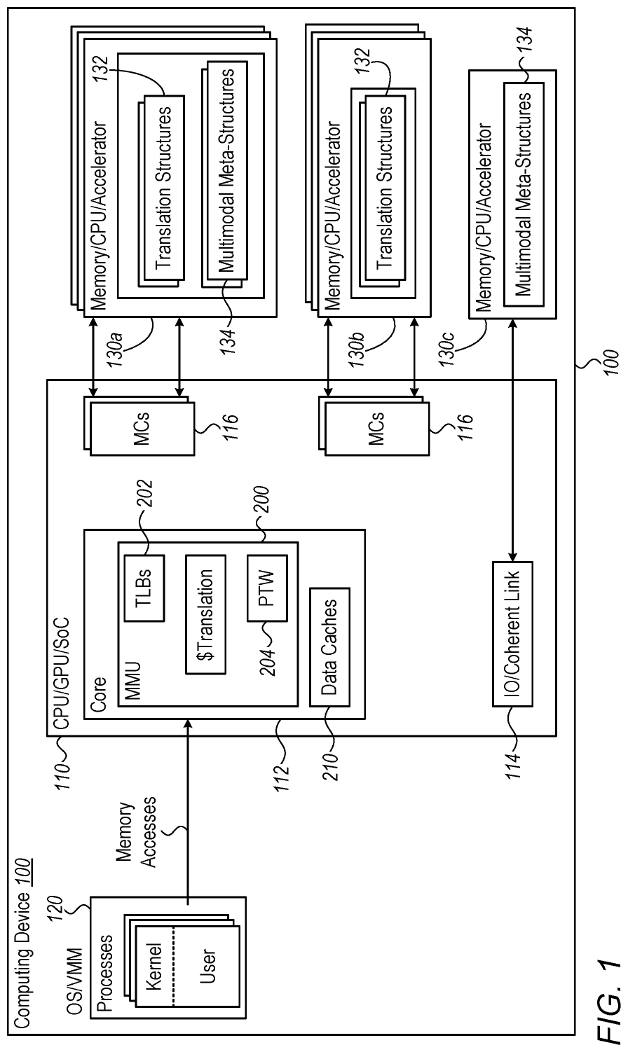

Actions may be taken in response to transactions or memory transaction requests, for example where to store data included in the transaction, changing provisioning on the fly, reallocating from e.g. persistent to other memory, etc. For example, a certain computer (e.g. depicted in FIG. 1; e.g. a machine executing in a server farm) may have 32 GB in local memory, known to the OS executing on that computer. If applications executing on that computer need more that 32G total, among them, embodiments of the invention may “fool” the local OS and other processes into thinking more memory exists, and may find this extra memory on other devices, e.g. other similar computers within the same facility. For example, embodiments may allow, among a group of servers, memory in an adjacent cabinet to be used, for the purpose of load balancing, taking into account SLAs, power required, speed, customer service level, etc. An embodiment may receive a transaction or request from a process executing on the computer system, e.g. a VM, or an OS, and may determine a translation or reprovisioning of memory for the process. This may be based on for example, telemetry, e.g. SLAs of the requesting process or other processes executing on the system; access frequency of memory systems among a plurality of memory systems; a prediction of future memory requests of the process, etc.

FIG. 1 shows a block diagram of an exemplary computing device which may be used with embodiments of the present invention. Computing device 100 may include a processor 110 that may be, for example, a CPU/GPU/system of a chip (SoC), a chip or any suitable computing or computational device; an operating system (OS) or a virtual machine manager (VMM) 120; and local memory resources or accelerators 130a-c.

Processor 110 may be configured to carry out methods described herein, and/or to execute or act as the various modules, units, etc. for example by executing code stored in a memory. More than one processor 110 or computing device 100 may be included in embodiments of the invention. Processor 110 may also execute a process or application requiring memory management as described herein. Memory resources 130a-c may include a computer or processor non-transitory readable medium, or a computer non-transitory storage medium, e.g., a RANI, storing instructions which when executed cause a processor to carry out embodiments of the invention.

OS 120 may be or may include any code segment designed and/or configured to perform tasks involving coordination, scheduling, arbitration, supervising, controlling or otherwise managing operation of computing device 100, for example, scheduling execution of programs and processes. Memory resources 130a-c may be or may include a plurality of, possibly different memory units, such as, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory resources 130a-c may be, for example, considered to be local to a processor, e.g. if they may be translated by MMU 200 onto an HPA; memory units 130a-c, or any other memory and storage units, may be considered to be peripherals, e.g. connected physically by a short link to the computer containing the processor; or physically distant from the processor, e.g. accessible via a common network, or in “the cloud”, located in a geographically distant location from the processor. In contrast to local memory, peripherals or physically distant memory resources may be considered remote.

Processor 110 may include at least one core 112, an input/output (TO) coherent link 114, and one or more memory controllers (MCs) 116. Core 112 may include or execute an MMU 200, including a translation lookaside buffers (TLBs) 210 and capable of performing translation actions using, e.g., page table walks (PTW) 220, in addition to data caches 210 as known in the art. Memory resources 130a-c may be considered local to processor 110, e.g., for having HPAs that may be translated from HVAs by MMU 200 within core 112, but as discussed may be external or distant memories.

In addition to conventional TSs 132, which are known in the art, some embodiments of the present invention involve multimodal meta structures 134 that include additional metadata associated with memory transactions or memory transaction requests—such as a TimeStamp, NumaID (processor NUMA ID or sub-NUMA ID), CoreID (Processor Core ID), VMid (Virtual Machine ID), PID (Process ID), PASID (Process Address Space ID), gVA (guest Virtual Address), gPA (guest Physical Address), DimmID (DIMM memory component ID), and the like—and may be used in various ways as demonstrated herein. In embodiments of the invention, TSs 132 and multimodal meta-structures 134 may be co-located within the same local memory resource 130a, or otherwise disjoint in separate local memory resources 130b and 130c or in combinations of co-located and disjoint structures (as demonstrated in computing device 100 as a whole). MCs 116 may have access to corresponding local memory resources or accelerators (e.g., 130a-b), from which they may store or make use of required TSs 132 and multimodal meta-structures 134. In some other embodiments, TSs 132 and multimodal meta-structures 134 may be located in separate, e.g., a local host DDR (double data rate) chip whereas multimodal meta-structures may be located in accelerator memory attached to the system.

By abstracting memory address spaces and separating memory address translation from memory resource provisioning based on, for example, a MAS, OS 120 may allocate virtual memory to a particular process, and then translate one or more parts of this virtual memory into MNAs within the MAS. These MNAs may be perceived as physical memory addresses from the point of view of OS 120 or a legacy or preexisting computer system. During the lifecycle of that process, parts of these OS-perceived physical memory addresses (which are, for example, in fact, MNAs) are thus not be explicitly translated onto any type of physical memory resources. MME may therefore dynamically change the CRA allocation, translation, and provisioning associated with any particular MNA, thereby enabling reprovision and exchange between memory types and locations in order to e.g., optimally match the workload requirements using a hybrid composition of memory resources; the MME may, for example, redistribute memory from local to remote locations or vice versa. MNA to CRA mapping/translation and CRA provisioning may therefore involve address and/or location randomization, which is known to provide valuable protection from memory usage based attacks as known in the art (e.g., in ASLR techniques). Such dynamic change may result in determining a translation or provisioning being performed differently for a first memory transaction request from an originating process and a subsequent identical memory transaction request from the same process.

A given CRA may point to any memory resource that may be provisioned by the MME (such as local or remote memory, persistent memory, storage memory, and so forth). Thus, the CRA space may be used abstract the underlying structure of the memory resources available to the system, e.g., in that the same address space is used for memory allocations, translations, and corresponding provisioning processes within the same physical resource, as well as for such processes involving different resources. In cases where the MME does not provision an CRA, the relevant MNA may, e.g., be translated to a blank CRA (no resource assigned).

In some embodiments, the MME may act as a lookaside entity for memory transactions and configurations made by OS 120 and involving TSs 132; e.g., it may not interfere, block, or delay such transactions and configurations. Consequently, in some embodiments, there may be no necessary impact on performance. The details of such transactions, e.g., the contents of entries made by the OS to the TSs, however, may be received (e.g., by receiving or intercepting memory transaction requests via, for instance, a snoop procedure) and processed offline (e.g., independently from the executed process) by the MME to create additional resource mapping, address translation and provisioning metadata, to be recorded in separate multimodal meta-structures that include, for instance, a particular mapping and translation of the relevant HVA to a corresponding HPA.

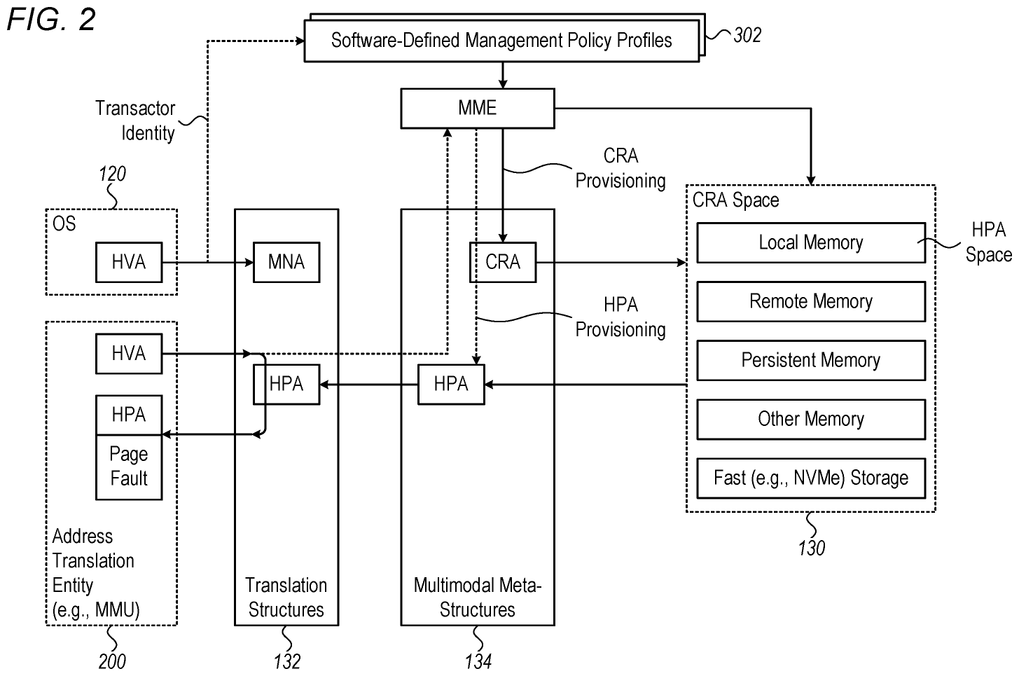

Reference is now made to FIG. 2, which shows a flow diagram of TS configuration associated with CRA and HPA provisioning according to some embodiments of the present invention. The configuration process may be carried out by a computer system such as depicted in FIG. 1. In prior art systems, an address or memory translation entity (which may be, e.g., MMU 200), simply translates a HVA onto an HPA using translation structure 132 (in the subsequent paragraphs, address translation entity will generally be referred to as ‘MMU’, although embodiments of the invention are not limited to present architectures associated with present-day address translation entities). Embodiments of the present invention may employ a more elaborate virtual-to-physical memory address translation procedure, employing a MAS. OS 120 may first map or translate an HVA into an MNA (which may, as said above, be perceived as an HPA from the OS 120 point of view). In some embodiments, the HVA to MNA mappings or translations may be documented in multimodal meta-structures 134, that may be used for establishing software-defined management policy profiles 302 that are implemented in MME 300, as further explained herein. MME 300 may then translate the MNA into a CRA—which represents a location within the physical address space created by all memory resources 130 available to the system (e.g., both local and remote). The CRA may, in turn, be provisioned by MME 300, e.g., using additional multimodal meta-structures 134 and translation structures 132. Finally, the provisioned CRA may be translated by MMU 200 onto an HPA within a given host. Such translation process may lead to provisioning of non-homogenous memory resources (e.g., associated with different hosts) within a single, unifying framework as explained herein, e.g. to unify several address spaces into a single address space.

In the case where a single OS or virtual machine spans across multiple virtual CPUs in multiple different platforms sharing the same CRA space, MME 300 may be instructed by an orchestrator or similar entity to reassign or duplicate CRAs and their memory contents to another MNA on the same platform, or, alternatively, to another MNA on a different platform under the control of another, different MME (or address translation entity), according to some embodiments of the invention. Thus unifying may produce a unified single address space including, e.g., an address space spanning a plurality of storage resources which may be shared between two or more computing systems.

In some embodiments of the invention, MMU 200 may be configured to consult multimodal meta-structures 134, e.g. by a mediator, or by configuring MME 300 to maintain a format for multimodal meta-structures 134 that is readable by MMU 200, instead of the conventional method where MMU 200 consults the TSs 132 written by OS 120. By consulting multimodal meta-structures 134, MMU 120 first reads the provisioned CRA (or translated HPA) as provided by the MME 300, and then proceeds with memory address translation and provisioning of corresponding memory resource as known in the art. In other embodiments, MMU 220 may be configured to consult TSs 132 configured by OS 120 (as in the conventional method). In such case, MME 300 may track the metadata and TSs associated with corresponding memory transactions, and translate the CRA pointing to the relevant HPA onto, e.g., a different MNA. Alternatively, the MME may respond with a deliberate indication of a page-fault exception that is intended to trigger software processing, e.g., for executing a context switch. In other embodiments, a translation request by OS 120 may be intercepted by MME 300 (e.g., using a snoop procedure) and further trigger immediate provisioning of an CRA—such that the corresponding memory request is not limited to local memory resources (and may, e.g., involve remote memory).

In some embodiments, MME 300 may implement multiple management policy profiles 302 that differentiate memory provisioning, address translation, and additional possible responses (such as receiving memory transaction requests or metadata, and storing metadata associated with, e.g., memory transactions or memory transaction requests, memory address translations and provisioning, etc.—in appropriate multimodal meta-structures 134). The selection of a given management policy profile may, for instance, depend on properties of the transaction itself, e.g., RD (read) vs. WR (write), alongside particular attributes of the transactor or originating process which configures and accesses the corresponding TSs (e.g., NumaID identifying the processor socket, CoreID identifying a particular processor core, Vmid identifying a particular Virtual Machine, PID process identification, PASID identifying a process address space, IOMMUid, and the like), or attributes of the transactee chosen as the target of the transaction (such as RemoteMemID identifying a remote memory store, DimmID of a memory component). Metadata associated with attributes of the transactor and entity (e.g., software accesses vs. page-table-walk accesses), may be transferred, e.g., by an MME 300 from one memory resource to another such that it will be visible to another, different MME.

In some embodiments, determining a translation or provisioning by MME 300 is performed differently for a first memory transaction request and a subsequent identical or substantially identical (e.g. similar address, same address, identical originating process, etc.) memory transaction request: for example, embodiments may change where and how data used by a specific application is stored, based on changing conditions, newly receive data, an analysis of a growing history, other processes' memory usage, etc. According to some embodiments of the invention, MME 300 may be configured to first respond to first-requester-with-first-data, and then to second-requester-with-second-data; for example, when two different OSs 120 or virtual machines associated with two different management policy profiles execute an instruction that requires memory address translation and provisioning, and that involves a single, particular TS—MME 300 may respond with a first set of data values to the first OS reads of a corresponding translation structure (e.g., mapping or translation of an HVA to an MNA, then to CRA, etc.) and a second set of data values to MMU 200 reads of the same translation structure (e.g., mapping or translation of an CRA to an MNA) that are associated with the 2n d OS 120.

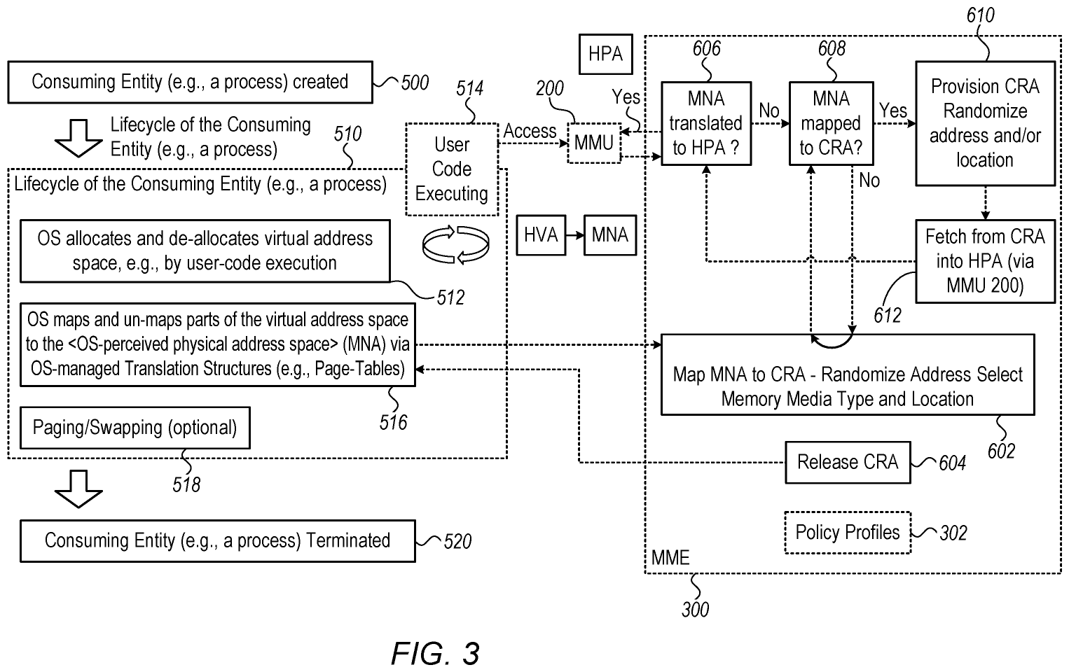

FIG. 3 shows a flowchart depicting a detailed memory allocation and provisioning procedure according to some embodiments of the present invention. The operations of FIG. 3 may be used with systems and data structures of FIGS. 1-3, but may be used with other systems and data structures. In operation 500, a memory consuming entity (e.g., a program executing on a processor such as an application or VM) is created or instantiated. Consequently, and throughout the lifecycle of a memory consuming entity (i.e., from 512 to 518), several operations may take place: in operation 512 the OS may allocate and deallocate virtual memory from the virtual address space—e.g., in accordance with user code in operation 514; memory paging/swapping (operation 518) may take place as part of this lifecycle as known in the art; in operation 516, OS 120 may map and un-map parts of the virtual address space to OS-perceived physical addresses (which are, in fact, MNAs within the MAS—managed by MME 300) via OS-managed TSs 132 (such as PTs). MME 300 may receive from a computing system or a memory translation entity on the computer system (e.g. from an OS, or an MMU), a memory transaction request originating from a process executing on the computing system (e.g. entity 500). The receiving may be by intercepting (e.g., using a snoop procedure) a translation request.

In case an HVA is translated by OS 120 to an MNA, MME 300 may, e.g., determine a translation or translate the MNA associated with the memory transaction request onto a corresponding CRA (which may, e.g., be allocated by MME 300) in 602. (While specific data structures such as a CRA are discussed, other data structures may be used to perform translation or provisioning as discussed herein.) Such translation may include address randomization (as known in the art for, e.g., ASLR methodology) according to management policy profiles 302. Conversely, in the case OS 120 unmaps the HVA from the MNA, MME 300 may respond such that the corresponding CRA allocation or provisioning is released 604. The user code in execution 514 may require memory transactions involving MMU 200 as known in the art (see also FIG. 2). As noted, in some embodiments of the present invention, memory translations by MMU 200 may be monitored by MME 300 using appropriate metadata (implemented, e.g., in multimodal meta structures). MME 300 may thus respond and further manage the corresponding memory transactions during code execution. MME 300 may first check whether an MNA has been translated by MMU 200 onto a HPA 606. If so, then MME 300 may simply allow MMU 200 to proceed according to the code in execution 514 (thus acting as a lookaside entity as explained above); if not, then MME 300 may further check whether the MNA has been translated onto an allocated CRA space 608. If such allocation and mapping or translation has been made, then MME 300 may translate and/or provision memory from one CRA onto another CRA according to, e.g., management policy profiles 302 in order to allow address or location randomization 610. MME 300 may then fetch 612 the resulting CRA into MMU 200 which, in turn, will translate that CRA into a HPA available to, e.g., a processor 110 within computing device 100. If, however, an MNA has not been translated onto an allocated CRA space, then MME 300 may allocate, translate and/or provision an appropriate CRA as in step 602, such that the subsequent steps 610-612 may take place. Thus, embodiments may determine a translation of a memory address associated with the memory transaction request, or determine a provisioning of memory for a translated address, based on for example metadata associated with memory transactions; the service level of the originating process; the service level of other processes executing on the computing system; access patterns of memory systems among a plurality of memory systems; and a prediction of future memory requests of the process.

After an CRA to HPA translation has been carried out, MMU 200 and MME 300 may repeat the above steps according to the running code in execution 514.

MNA to CRA allocation, translating, mapping or provisioning by MME 300 may be performed according to management policy profiles 302 as explained (e.g. with regard to FIG. 2). Such workflow may take place throughout the entire lifecycle of a given memory consuming entity until termination (e.g., a program reaches a stop bock) in 520.

Embodiments may use machine learning (ML), e.g. neural networks (NNs), to perform actions such as translations, provisioning, or predict the next action of certain processes based on past telemetry or history, in order to make a decision on how to satisfy a new transaction, e.g. where to store memory, if to re-allocate, etc. Such ML may perform translation or provisioning, where the ML model is trained to optimize memory usage. In some embodiments, an NN may be configured to take as input or consume metadata (including, e.g., telemetry metadata as demonstrated herein) associated with a memory transaction; a particular workload or set of memory transactions; or a set of workloads or memory transactions associated with a plurality of processes (running, for instance, on separate computing systems). The NN may first be trained with metadata generated based a given workload, either offline, or online during a period of run-time. The output of the NN may then used to generate additional actions, e.g., altering memory storage, fetching contents of one memory address into another, or address translation from remote to local memory—which may be used for optimization of memory usage. An output from the NN may also be used for, e.g., determining whether to perform an operation on parts of the memory associated with a memory transaction, e.g., on the cache-line requested by a read memory transaction, or, e.g., perform an operation on the whole data page.

In some embodiments of the invention, MME 300 may include different modules in its internal structure, each of which may be responsible for performing different functions and operations by MME 300. Some embodiments may include an access intercept module, responsible for, e.g., intercepting an OS/Hypervisor access to translation structures (e.g., according to memory allocations, or to updating of translation structures due to memory translation), and MMU accesses to translation structures for the translation of a virtual address (e.g., page table walk). Embodiments may also include a module for monitoring memory usage patterns (such as access frequency) based on telemetry metadata associated with memory transactions. Telemetry metadata may include, e.g., TransactorID, additional tags representing the initiator of the memory transaction (e.g., SocketID, NumaID, CoreID, VmID, ProcesID, PASID, MmuID, etc.), TransacteeID, additional tags representing the target of the memory transaction (e.g., DimmID, MemoryControllerID, RemoteMemoryID, etc.), and other transaction tags associated with, e.g., nested virtualizations, such as ones involving an GVA (Guest Virtual Address), an GPA (Guest Physical Address), or an HPA (Host Physical Address). Different embodiments of the invention involve different implementations of MME 300 in, e.g., software, hardware, firmware, or combinations the former.

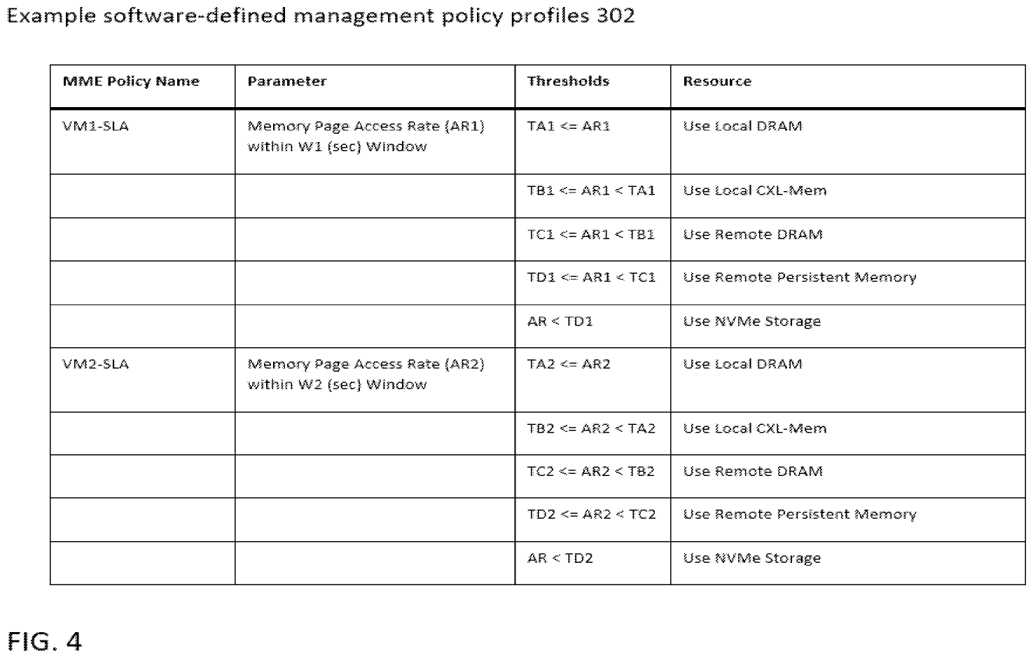

Reference is now made to FIG. 4, which illustrates an example software-defined management policy profiles 302 table, which may be used in some embodiments of the present invention to define policies which may affect storage, according to some embodiments. Policies may be identified by policy name associated with an executing VM and an SLA. A policy may be triggered (e.g. have its action taken, such as in the Resource column) based on matching to one or more parameters, such as a memory page access rate (AR) within a time window Wn (n=1, 2, . . . ) exceeding a pre-defined threshold Txi (where i=1, 2 . . . is a number associated with a specific policy and X=A, B, . . . is the threshold number) or being found between two different thresholds. Triggering of a policy may involve a response from MME 300 that may include e.g., an action of using specific memory resources (e.g., Local DRAM, Local CXL-Mem, Remote DRAM, Remote Persistent Memory, and so forth) for future memory allocations, translations and provisioning, as can be seen in a Resource column.

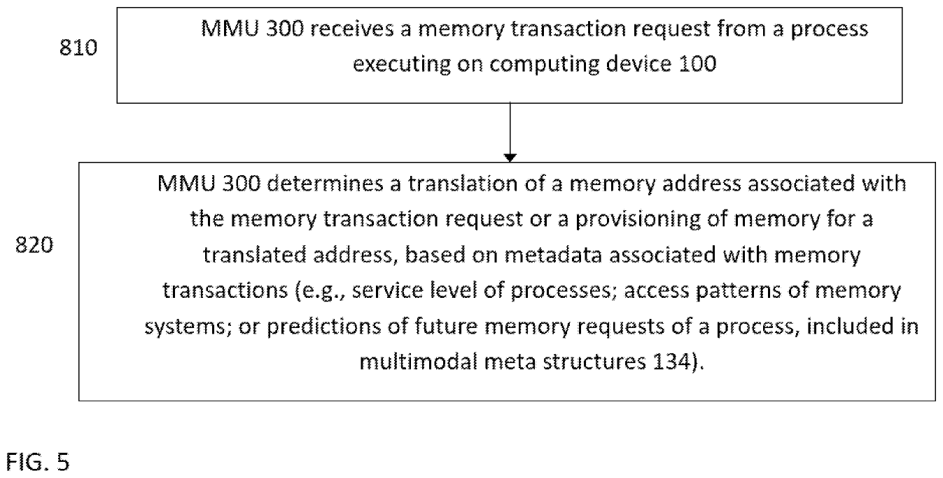

FIG. 5. Depicts a flowchart depicting a simple process of managing memory resources in a computing system according to some embodiments of the present invention. In step 810, MMU 300 may receive a memory transaction request (e.g., read or write) from a process executing on computing device 100. In the subsequent step 820, MMU 300 may determine a translation of a memory address (e.g., an MNA or CRA) associated with the memory transaction request or a provisioning of memory (e.g., associated with an CRA or HPA) for a translated address, based on metadata associated with memory transactions (e.g., service level of processes; access patterns of memory systems; or predictions of future memory requests of a process) which may, e.g., be included in multimodal meta structures 134.

In the description and claims of the present application, each of the verbs, “comprise”, “include” and “have”, and conjugates thereof, are used to indicate that the object or objects of the verb are not necessarily a complete listing of components, elements or parts of the subject or subjects of the verb. Unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of an embodiment as described. In addition, the word “or” is considered to be the inclusive “or” rather than the exclusive or, and indicates at least one of, or any combination of items it conjoins.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In detailed description, some features or elements described with respect to one embodiment or flowchart can be combined with or used with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

Descriptions of embodiments of the invention in the present application are provided by way of example and are not intended to limit the scope of the invention. The described embodiments comprise different features, not all of which are required in all embodiments. Embodiments comprising different combinations of features noted in the described embodiments, will occur to a person having ordinary skill in the art. Some elements described with respect to one embodiment may be combined with features or elements described with respect to other embodiments. The scope of the invention is limited only by the claims.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A method of managing memory resources in a computing system, the method comprising:
receiving from a computing system comprising a memory translation entity, a memory transaction request originating from a process executing on the computing system; and
determining a translation of a memory address associated with the memory transaction request or a provisioning of memory for a translated address, based on one or more of metadata associated with memory transactions; the service level of the process; the service level of other processes executing on the computing system; access patterns of memory systems among a plurality of memory systems; and a prediction of future memory requests of the process.

2. The method of claim 1, wherein the translation or provisioning is transparent to an operating system executing on the computing system.

3. The method of claim 1, wherein the translation or provisioning comprise unifying several address spaces into a single address space.

4. The method of claim 3, wherein the unifying produces a unified single address space comprising an address space spanning a plurality of storage resources.

5. The method of claim 1, wherein the translation or provisioning is to two or more address spaces.

6. The method of claim 1, wherein the translation or provisioning are performed based on a machine learning model trained using one or more of metadata associated with memory transactions to optimize memory usage.

7. The method of claim 1, wherein determining a translation or provisioning is performed differently for a first memory transaction request and a subsequent identical memory transaction request.

8. The method of claim 1, wherein the one or more metadata comprise telemetry data collected from internal busses or software transaction parameters associated with an execution unit.

9. The method of claim 5, wherein parts of the two or more address spaces are under the control of a different computing system or address translation entity.

10. The method of claim 1, wherein determining a translation of a memory address comprises intercepting a translation request associated with the process executing on the computing system.

11. A system for managing memory resources in a computing system, comprising, using a computer processor:
a memory and;
a processor configured to:
receive from a computing system comprising a memory translation entity, a memory transaction request originating from a process executing on the computing system; and
determine a translation of a memory address associated with the memory transaction request or a provisioning of memory for a translated address, based on one or more of metadata associated with memory transactions; the service level of the process; the service level of other processes executing on the computing system; access patterns of memory systems among a plurality of memory systems; and a prediction of future memory requests of the process.

12. The system of claim 11, wherein the translation or provisioning is transparent to an operating system executing on the computing system.

13. The system of claim 11, wherein the translation or provisioning comprise unifying several address spaces into a single address space.

14. The system of claim 13, wherein the unifying produces a unified single address space comprising an address space spanning a plurality of storage resources.

15. The system of claim 11, wherein the translation or provisioning is to two or more address spaces.

16. The system of claim 11, wherein the translation or provisioning are performed based on a machine learning model trained using one or more of metadata associated with memory transactions to optimize memory usage.

17. The system of claim 11, wherein determining a translation or provisioning is performed differently for a first memory transaction request and a subsequent identical memory transaction request.

18. The system of claim 11, wherein the one or more metadata comprise telemetry data collected from internal busses or software transaction parameters associated with an execution unit.

19. The system of claim 15, wherein parts of the two or more address spaces are under the control of a different computing system or address translation entity.

20. The system of claim 11, wherein the translation of a memory address comprises intercepting a translation request associated with the process executing on the computing system.
